(19) United States
(12) Patent Application Publication
(10) Pub. No.: US 2006/0243859 A1
(43) Pub. Date: Nov. 2, 2006

(54) On-board system for generating and supplying oxygen and nitrogen

(76) Inventors: Stephane Lessi, Newark, DE (US); Olivier Vandroux, Grenoble (FR)

Correspondence Address: AIR LIQUIDE, 2700 POST OAK BOULEVARD, SUITE 1800, HOUSTON, TX, 77056, US

(21) Appl. No.: 10/559,044

(22) PCT Filed: May 24, 2004
(86) PCT No.: PCT/FR04/01276

§ 371 Date: Apr. 27, 2006

(30) Foreign Application Priority Data
Jun. 5, 2003 (FR) 03/06794

(51) Int. Cl. B64D 11/00

(52) U.S. Cl. 244/118.5

(57) ABSTRACT

The on-board system comprises: an OBIGGS (2) that supplies, via outlet (6), nitrogen for inerting compartments (15, 16, 17) of an aircraft; a first OBOGS (3) that supplies oxygen to a supply circuit (19) for aircraft occupant masks (20, 21), the OBIGGS (2) and first OBOGS (3) being supplied with compressed air coming from the aircraft engines (13), and; a second solid electrolyte OBOGS (4) that furnishes, via outlet (24), pressurized pure oxygen stored in a pressurized oxygen tank (26) that can be connected to the oxygen supply line (19).

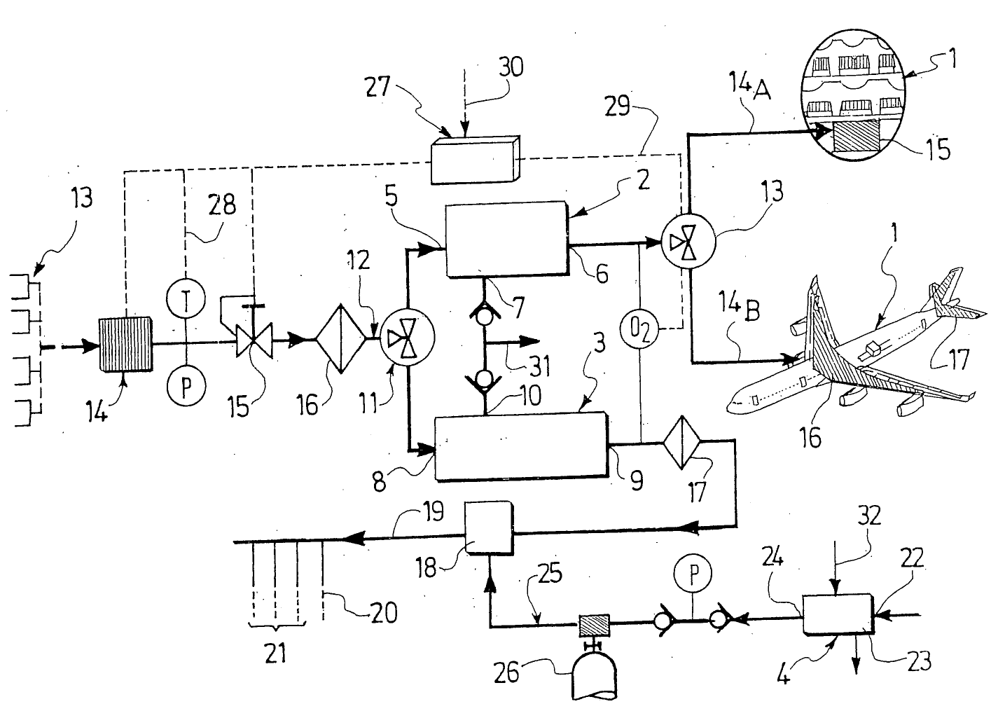

The present invention relates to onboard systems for generating and supplying oxygen (referred to in aeronautics by the acronym “OBOGS”) and nitrogen (referred to in aeronautics by the acronym “OBIGGS”).

Historically, OBOGS devices were developed first, to supply oxygen to pilots of military aircraft, and then, more recently, for continuous supply to aircraft passengers. OBOGS devices are generally of the air component separation type using pressure swing adsorption denoted by the acronym PSA.

OBIGGS devices then appeared for inerting fuel tanks of helicopters, and later of civilian aircraft. OBIGGS devices are generally of the air component separation type using polymer membrane permeation. Combined OBOGS/OBIGGS systems were developed in the 1980s, as described, for example, in document U.S. Pat. No. 4,681,602 (Boeing) or in U.S. Pat. No. 5,069,692 (Sundstrand), where the OBOGS is supplied with the nitrogen-depleted mixture from the OBIGGS device.

Simultaneously, devices for supplying oxygen from air in ion-transport membranes of the solid-electrolyte type, referred to as SEOS, developed industrially in the 1980s, as described in document WO-A-91/06691 (Ceramatec), and capable of supplying pressurized oxygen from air at ambient pressure, were proposed as OBOGS devices, optionally also for supplying nitrogen for tank inerting, as described in document U.S. Pat. No. 5,169,415 (Sundstrand).

Following a thorough investigation of the oxygen needs, on the one hand, and the nitrogen needs, on the other, of civilian large-capacity transport aircraft, the inventors reached the conclusion that combined OBOGS and OBIGGS systems, whether of the adsorption or permeation type, were industrially unfeasible, and that the outputs allowed by the solid electrolyte devices were unable to supply the anticipated outputs.

A need therefore exists for systems for supplying oxygen or nitrogen suitable for large transport aircraft with output/weight ratios and production and maintenance costs that do not exacerbate the operating costs of these aircraft.

For this purpose, the invention proposes an onboard system for generating and supplying oxygen and nitrogen, comprising:

a first air separation device with an air inlet and at least one outlet;

a second air separation device with an air inlet and an outlet;

a third air separation device with an air inlet and at least one outlet,

the air inlets of the first and second devices being able to be connected to a pressurized air source;

the first separation device having an outlet that can be connected to at least one compartment to be inerted; and

the outlets of the second and third separation devices being able to be connected to an oxygen supply circuit.

According to particular features of the invention:

the third air separation device is of the solid-electrolyte type;

the outlet of the third air separation device can be connected to an onboard oxygen tank;

the second air separation device is advantageously of the adsorption type,

the first air separation device is advantageously of the polymer membrane type.

Other features and advantages of the invention will appear from the following description of embodiments, given for illustration but nonlimiting, in relation to the drawing appended hereto, in which:

The single FIGURE schematically shows an onboard system for generating and supplying oxygen and nitrogen according to the invention.

In the embodiment shown in the single FIGURE, the onboard system in a civilian large-capacity transport aircraft, generally designated by the numeral 1, essentially comprises a first air separation device of the OBIGGS 2 type, a second air separation device of the OBOGS 3 type, and a third air separation device of the OBOGS 4 type.

The OBIGGS 2 air separation device, advantageously of the polymer membrane type, like those sold by Medal Corp. in the United States, comprises a pressurized air inlet 5, a nitrogen-enriched mixture outlet 6, and a nitrogen-depleted mixture outlet 7.

The OBOGS 3 air separation device, advantageously of the PSA type, with high-performance adsorbents, for example zeolite LiLSx adsorbents, like those marketed by the Applicant, comprises a pressurized air inlet 8, an oxygen-enriched mixture outlet 9, and an oxygen-depleted mixture outlet 10.

The inlets 5 and 8 of the first (2) and second (3) air separation devices can be connected, via a distribution/control valve 11, to a feed line 12 issuing from compressor stages of the engines 13 of the aircraft 1, the line 12 passing through a heat exchanger 14 to cool the compressed gas from the engines, and incorporating a control valve 15 and an upstream filter 16.

The nitrogen outlet 6 of the OBIGGS 2 device is connectable, via a distribution valve 13, to circuits 14a 14b for inerting baggage holds for goods transport 15 or fuel tanks 16, 17, supplying the propulsion engines and the auxiliary energy supply equipment of the aircraft.

The oxygen outlet 9 of the OBOGS 3 device is connected, via a downstream filter 17 and a flow controller 18, to a circuit 19 for supplying oxygen to the masks 20 of the pilot cabin and 21 of the aircraft passengers.

The OBOGS 4 ceramic membrane air separation device, advantageously of the yttrium-doped zirconia type, comprises an electric power inlet 32, a cabin pressure air intake inlet 22, an oxygen-depleted mixture outlet 23 and a high purity oxygen (purity higher than 99.9%) outlet 24 at a pressure above 100 bar absolute in a secure line 25 terminating in the flow control device 18 and incorporating a pressurized oxygen buffer tank 26.

The control valve 15 is controlled by an electronic control device 27 receiving pressure and temperature signals 28 upstream of the line 12 and oxygen content measurement signals 29 in the outlet lines of the separation devices 2 and 3 and setpoint signals 30 from the flight deck.

In the embodiment shown, the waste outlets 7 and 10 of the separation devices 2 and 3 communicate with a line 31 for discharge outside the aircraft.

With the arrangement described above, it is clear that the separation devices 2 and 3 can be implemented sequentially and/or temporarily simultaneously to supply nitrogen and oxygen respectively using compressed air from the engines, and that the ultrapure oxygen reserve in the tank 26, which can be replenished at will by actuating the separation device 4, can be used, after dilution, to supplement all or part of the medium-purity oxygen flow available at the outlet 9 of the separation device 3.

In a particular embodiment, suitable for large transport aircraft, the OBIGGS 2 can supply an output of 150 to 250 m³/h, typically of about 200 m³/h of gas mixture having a nitrogen content above 90% at a gauge pressure of 2-3 bar, and the ceramic OBOGS 4 can supply an output of 0.05 to 0.1 m³/h of pure oxygen at a pressure above 110 bar, typically of about 130 bar.

Although the invention has been described in relation to particular embodiments, it is not limited thereto but is susceptible to modifications and variants that will appear to a person skilled in the art within the framework of the claims below.

1-8. (canceled)

9. An onboard system for generating and supplying oxygen and nitrogen, comprising:
a) a first air separation device with an air inlet and at least one outlet;
b) a second air separation device with an inlet and at least one outlet;
c) a third air separation device with an air inlet and at least one outlet;
the inlets and of the first and second separation devices being able to be connected to a pressurized air source,
1) the outlet of the first separation device being able to be connected to at least one compartment to be inerted; and
2) the outlets of the second and third separation devices being able to be connected to a circuit for supplying oxygen to passengers.

10. The system as claimed in claim 9, characterized in that the third separation device is of the solid electrolyte type.

11. The system as claimed in claim 10, characterized in that the outlet of the third separation device can be connected to a pressurized oxygen tank.

12. The system as claimed in claim 10, characterized in that the solid electrolyte is based on doped zirconia.

13. The system as claimed in claim 9, characterized in that the second separation device is of the pressure swing adsorption type.

14. The system as claimed in one claim 9, characterized in that the first separation device is of the polymer membrane permeation type.

15. The system as claimed in claim 9, characterized in that the compartment to be inerted is a baggage hold.

16. The system as claimed in claim 9, characterized in that the compartment to be inerted is a fuel tank.
